(19) United States
(12) Patent Application Publication
(10) Pub. No.: US 2026/0011804 A1
(43) Pub. Date: Jan. 8, 2026

(54) NON-DESTRUCTIVE METHOD OF RECYCLING SECONDARY BATTERY ELECTRODE MATERIALS USING PLASMA PROCESS

(71) Applicant: Korea Institute of Energy Technology, Naju-si (KR)

(72) Inventors: Dong Han SEO, Naju-si (KR); Sun Woo KIM, Naju-si (KR); So Young LEE, Naju-si (KR); Ki Ho BAE, Seoul (KR); Seonwoo CHOI, Busan (KR)

(21) Appl. No.: 19/256,193

(22) Filed: Jul. 1, 2025

(30) Foreign Application Priority Data
Jul. 4, 2024 (KR) 10-2024-0087880

(51) Int. Cl. H01M 10/54; C22B 3/00; C22B 7/00; C22B 21/00; C22B 23/02; C22B 47/00; H01M 10/0525

(52) U.S. Cl. CPC H01M 10/54; C22B 7/001; C22B 7/006; C22B 21/0069; C22B 23/02; C22B 23/0453; C22B 47/00; H01M 10/0525

(57) ABSTRACT

The present disclosure relates to a non-destructive method of recycling secondary battery electrode materials using a plasma process, and specifically to a method of recycling electrode materials by separating and recovering them from unused lithium secondary batteries. More specifically, the surface of an electrode separated from a lithium secondary battery is treated with plasma and the current collector is separated and recovered with no deformation in a non-destructive manner, and cathode or anode active materials are recovered intactly through an organic solvent treatment step. If necessary, impurities are removed through an additional heat treatment step to increase crystallinity, and thus electrode materials can be recovered in a form capable of being used directly with no additional process and reused for manufacturing lithium secondary batteries.

### CROSS-REFERENCE TO RELATED APPLICATION

This application claims priority to Korean Patent Application No. 10-2024-0087880, filed on Jul. 4, 2024, and all the benefits accruing therefrom under 35 U.S.C. § 119, the contents of which in its entirety are herein incorporated by reference.

### BACKGROUND

### 1. Field

The present disclosure relates to a non-destructive method of recycling secondary battery electrode materials using a plasma process. Specifically, the present disclosure relates to a recycling method in which the surfaces of waste or used electrodes and unused secondary battery electrodes are treated with vacuum or atmospheric pressure plasma to separate the active material from the current collectors in a non-destructive manner, and cathode or anode active materials are separated and recovered wholly through a step of heating a solution containing a mixture of organic or non-organic solvents where there is a differences in boiling points between the two different solvents where solvent of lower boiling point is evaporated while carrying the light weight binder and conductive agent leaving behind the active material at the bottom side with the solvent exhibiting a higher boiling point so that active material is directly reused for production of lithium secondary batteries.

### 2. Description of the Related Art

The secondary battery industry continues to have increasing industrial importance as it has become a key technology in various applications including smartphones, tablet PCs, electric vehicles, energy storage devices, or the like. Secondary batteries, which are mainly applied to portable electronic instruments, have been actively researched and developed as concerns about the global environment and fossil fuel depletion have increased, and the demand for secondary batteries is expected to increase further as the electric vehicle market expands in the future.

Battery recycling is also emerging as an important issue as the electric vehicle and battery industries grow significantly. In particular, metals, such as nickel, cobalt, manganese and lithium, used as cathode materials, are expensive raw materials and buried in limited places, and their sources are highly dependent on overseas imports, and thus recycling technologies of secondary battery materials are essential technologies that can greatly reduce the dependence of secondary battery resources in Korea on foreign countries.

Methods of recycling secondary batteries widely used currently include a pretreatment step of separating waste or faulty cells and unused secondary batteries to recover waste electrodes (cathodes/anodes), and a post-treatment step of dissolving the waste electrode (cathode/anode current collectors+cathode/anode active materials coated on the current collectors+conductive agent+binder) in a strong acid. In this manner, acidic black powder waste water containing various metal ions is generated. Herein, introduction of a large amount of high-concentration alkaline water causes conversion of the metal ions into powder not dissolved in the solvent. This is called a co-precipitation process, and the powder obtained through a chemical step is collected and separated, and then a process of resynthesizing a cathode material is carried out through a high-temperature heat treatment process. Also, in the case of current collectors, recycling is allowed merely after a high-temperature firing step of converting the obtained powder into aluminum foil is carried out again.

However, such chemical processes and extensive heating processes have a possibility of penetration of various foreign materials and require a step of recombining elementalized precursors, and thus cause such problems as low efficiency, complicated processes, taking a long time, generation of various highly dangerous waste water and a need for high energy. Under these circumstances, there is a need for developing a novel recycling technology.

### REFERENCES

### Patent Documents

(Patent Document 1) Korean patent publication No. 10-2460833
(Patent Document 2) Korean patent publication No. 10-2500820
(Patent Document 3) Korean patent publication No. 10-2552186

### SUMMARY

To solve the above-mentioned problems, the present disclosure is directed to providing a method for intactly recovering and recycling active materials and current collectors of secondary batteries by using a non-destructive, eco-friendly, low-energy and high-speed technology using a plasma process.

In one aspect, there is provided a method for recycling a secondary battery electrode material, including the steps of: (A) applying vacuum plasma or atmospheric pressure plasma to the surface of a secondary battery electrode to perform plasma treatment; (B) dipping the plasma-treated electrode in a first organic solvent and carrying out ultrasonication; and (C) dipping the ultrasonicated electrode in a solution containing the first organic solvent and carrying out heating to the boiling point of the first organic solvent or lower, wherein the solution of step (C) is a solution containing a mixture of the first organic solvent with water or a second organic solvent.

The method according to the present disclosure can recover and recycle active materials and current collectors of cathodes or anodes of discarded or unused secondary batteries intactly as they are, includes a simple process requiring no multi-step chemical process and long-time heat treatment process, and importantly, there is no need for complete re-synthesis of the active material involved thus maximizing the process efficiency by virtue of its rapid processing time.

In addition, the method according to the present disclosure can ensure cost-efficiency since it includes a low-energy, low-cost process.

However, the effects of the present disclosure are not limited to the above-mentioned effects. It should be understood that the effects of the present disclosure include all effects that can be inferred from the following description.

### BRIEF DESCRIPTION OF THE DRAWINGS

FIG. 1 is a schematic view illustrating a process flow according to the present disclosure.

FIG. 2 illustrates how a current collector is separated through an ultrasonication process.

FIG. 3 illustrates a current collector before and after an ultrasonication process.

FIG. 4 illustrates how a cathode active material is separated by an organic solvent (acetone)/water treatment process.

FIG. 5 shows results of scanning electron microscopy (SEM) and energy dispersive spectroscopy (EDS) analysis of a cathode before plasma treatment.

FIG. 6 shows results of SEM and EDS analysis of a cathode after plasma treatment.

FIG. 7 is a graph illustrating results of X-ray photoelectron spectroscopy (XPS) of a cathode before and after plasma treatment.

FIG. 8 shows results of SEM and EDS analysis of a conductive agent and a binder remaining after separating a cathode active material.

FIG. 9 is a graph illustrating results of Raman analysis of a cathode active material (NCM, nickel cobalt manganese) separated after plasma treatment.

FIG. 10 shows results of SEM and EDS analysis of a cathode active material separated by the process of Example 1-1 according to the present disclosure.

FIG. 11 is a graph illustrating results of X-ray diffractometry (XRD) analysis of a cathode active material before and after the process of Example 1-1 according to the present disclosure.

FIG. 12 shows results of SEM and EDS analysis of a current collector separated by the process of Example 1-1 according to the present disclosure.

FIG. 13 is a graph illustrating results of XRD analysis of a current collector before and after the process of Example 1-1 according to the present disclosure.

FIG. 14 is a graph illustrating results of XPS analysis of a current collector before and after the process of Example 1-1 according to the present disclosure.

FIG. 15 shows results of atomic force microscopy (AFM) analysis of a current collector before the process of Example 1-1 according to the present disclosure.

FIG. 16 shows results of AFM analysis of a current collector after the process of Example 1-1 according to the present disclosure.

FIG. 17 is a graph illustrating an I-V curve of a current collector separated by the process of Example 1-1 according to the present disclosure.

FIG. 18 shows results of SEM analysis of a cathode active material separated by the process of Example 1-2 according to the present disclosure.

FIG. 19 shows results of SEM analysis of a cathode active material separated by the process of Example 1-3 according to the present disclosure.

FIG. 20 illustrates how a cathode active material is separated by an organic solvent (acetone)/organic solvent (ethylene glycol/propylene glycol) process of Example 1-2.

### DETAILED DESCRIPTION

Hereinafter, the present disclosure will be explained in detail with reference to the accompanying drawings.

In one aspect, the present disclosure relates to a method of recycling electrode materials of waste secondary batteries and unused secondary batteries, and specifically to a recycling method in which the electrode materials are separated intactly and recovered wholly in a non-destructive manner by using a vacuum plasma or atmospheric pressure plasma process so that they may be reused for production of lithium secondary batteries.

Particularly, the method includes the steps of: (A) applying vacuum plasma or atmospheric pressure plasma to the surface of a secondary battery electrode to perform plasma treatment; (B) dipping the plasma-treated electrode in a first organic solvent and applying ultrasonic waves thereto; and (C) dipping the ultrasonicated electrode in a solution containing the first organic solvent and carrying out heating to the boiling point of the first organic solvent or lower, wherein the solution of step (C) is a solution containing a mixture of the first organic solvent with water or a second organic solvent.

Herein, the electrode may be a cathode including a cathode active material, a cathode current collector, a conductive agent and a binder, or an anode including an anode active material, an anode current collector, a conductive agent and a binder.

In addition, the method may further include, after step (C), step (D) of heat treating the cathode or anode active material obtained through step (C), wherein the heat treatment step may be carried out preferably at a temperature ranging from 300° C. to 900° C. for 30 minutes to 3 hours. When the heat treatment step is carried out, impurities of the cathode or anode active material remaining in the process may be further removed, and the crystallinity may be further increased.

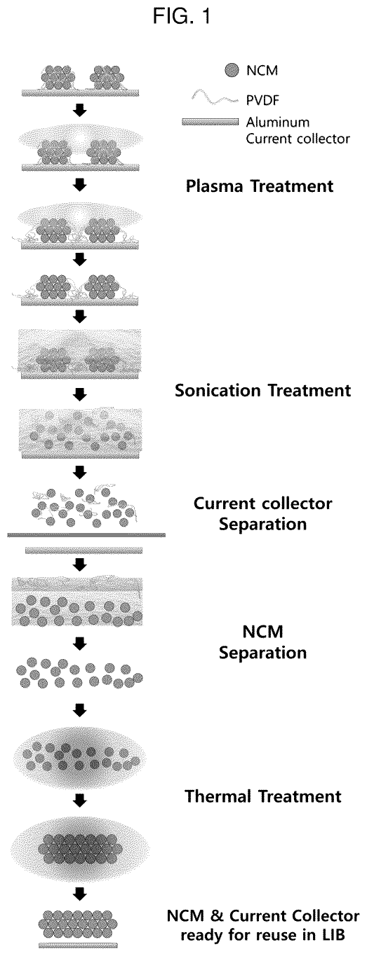

The process flow of steps (A) to (D) according to the present disclosure can be confirmed through the schematic view as shown in FIG. 1.

According to the present disclosure, step (A) is a plasma processing step intended to separate a binder which allows strong binding of an electrode material with a current collector through vacuum or atmospheric pressure plasma treatment. The binder and the conductive agent may be separated from each other while they are agglomerated by plasma applied to the surface of a separated electrode.

Herein, in the vacuum plasma process of step (A), it is preferred that plasma is discharged at 10-1000 W under the atmosphere of a mixed gas containing argon (Ar) and applied for 5 minutes to 1 hour. It is also preferred that the mixed gas is a gas containing argon (Ar) mixed with at least one selected from the group consisting of oxygen (O₂), hydrogen (H₂) and nitrogen (N₂).

In addition, in the atmospheric pressure plasma process of step (A), it is preferred that plasma is discharged at 10-1000 W under the atmosphere of Ar or air or oxygen (O₂) or nitrogen (N₂) alone, or under the atmosphere of a mixed gas containing argon (Ar) and applied for 5 minutes to 1 hour. It is also preferred that under the atmospheric condition, air is most preferred gas while the mixed gas is a gas containing argon (Ar) mixed with at least one selected from the group consisting of oxygen (O₂), hydrogen (H₂), nitrogen (N₂) and helium (He) could also be used.

Further, the method may further include, before step (A), step (a-1) of carrying out pretreatment of separating a cathode, an anode and a separator from a secondary battery discarded after use. For a process of peeling and desorbing a cathode plate coated with a cathode active material, a step of cutting the cathode plate into a predetermined size may be carried out. In addition, the cathode plate may be cut into a jelly-roll type or stacked type for desorption reaction, and a cutting step may be omitted in the case of an electrode already cut into a predetermined size.

According to the present disclosure, step (B) is an ultrasonication processing step intended to separate the plasma-treated and separated current collector and coated electrode materials quickly and completely and to recover them intactly. The active material, conductive agent and binder can be separated quickly from the current collector by introducing the electrode surface-treated with plasma to an ultrasonicator filled with a first organic solvent or water or mixture of organic solvent & water and applying ultrasonic waves thereto. A foil-like current collector can be separated and recovered intactly through step (B).

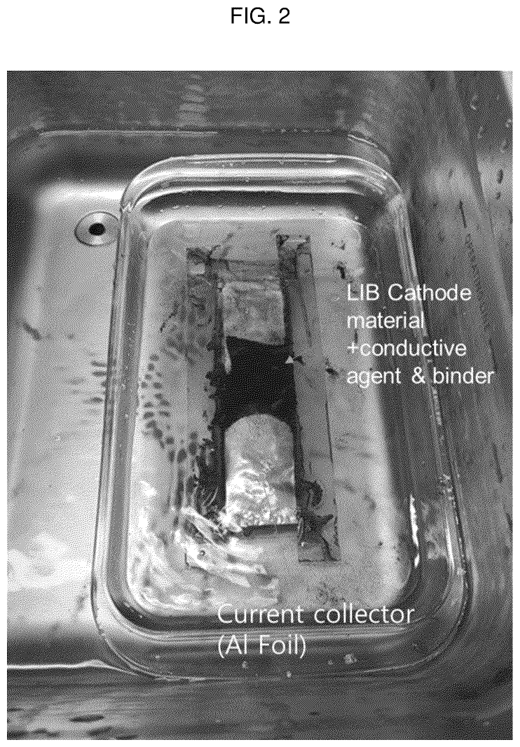

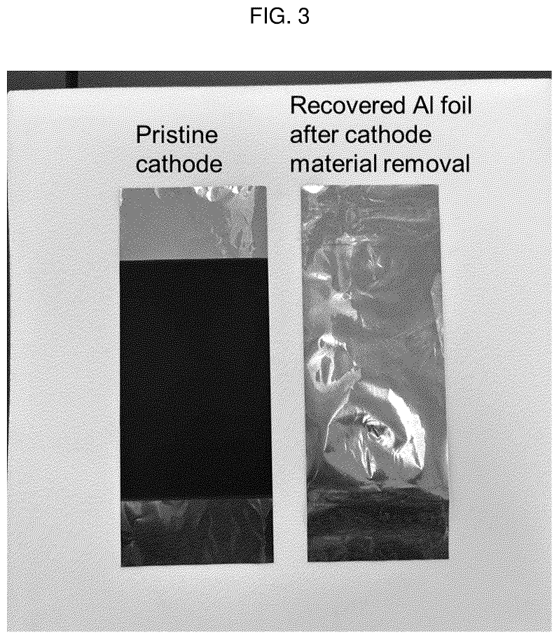

Referring to FIG. 2 and FIG. 3, a foil-like cathode current collector separated completely through step (B) and the cathode materials (active material+conductive agent+binder) as residues can be seen.

According to the present disclosure, step (C) is an organic solvent treatment step intended to re-separate and recover only the active material from the residues. After step (B), the residues (active material+conductive agent+binder) remaining in the form of slurry are recovered, dried and dipped in a solution containing a first organic solvent, and then heating is carried out to a temperature of the boiling point of the first organic solvent or lower, or a temperature close thereto so that the active material may be separated.

Particularly, when the solution is heated to a temperature of the boiling point of the first organic solvent or lower, or a temperature close thereto, the binder and conductive agent float to the surface of the solution while the active material sinks down, and thus it is possible to recover the active material only.

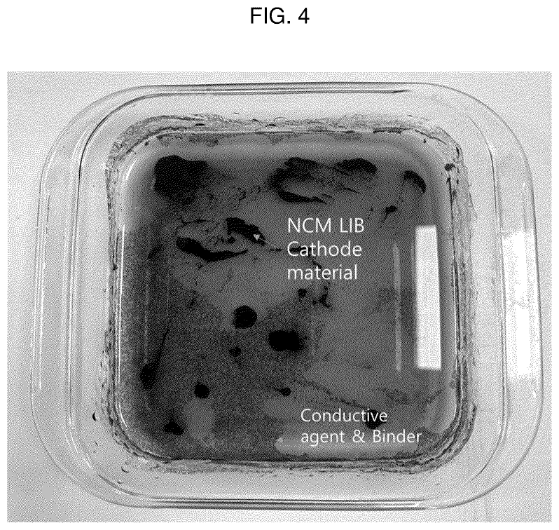

Referring to FIG. 4, the cathode active material re-separated from the residues through step (C) can be seen.

In addition, the solution containing the first organic solvent may be a solution mixed with water or a second organic solvent, wherein the second organic solvent is preferably an organic solvent having a higher boiling point and higher density as compared to the first organic solvent and showing a large difference in boiling point and density.

Further, the first organic solvent is preferably an organic solvent having a lower boiling point and lower density as compared to the second organic solvent and should be a solvent capable of dissolving the binder. There is no particular limitation in use of the first organic solvent, as long as it is one used conventionally in the art.

Particularly, the first solvent preferably is at least one selected from the group consisting of acetone, ethanol, methanol, benzene, chloroform, ethylene dichloride, ethyl acetate, acetonitrile, n-hexane, cyclohexane, tetrahydrofuran (THF), N-methyl pyrrolidone (NMP), dimethyl carbonate (DMC), ethyl carbonate (EC), water and a mixture thereof, and more preferably, acetone, ethanol or chloroform and water.

Most preferably, low-toxic eco-friendly acetone or water or acetone/water mixture is used.

In addition, the second organic solvent is preferably an organic solvent having a higher boiling point and higher density as compared to the first organic solvent. There is no particular limitation in use of the second organic solvent, as long as it is one used conventionally in the art.

Particularly, the second solvent preferably is at least one selected from the group consisting of ethylene glycol (EG), propylene glycol (PG), polyethylene glycol (PEG), triethylene glycol (TEG), NMP, DMC, EC and a mixture thereof, more preferably, ethylene glycol, propylene glycol, triethylene glycol (TEG) or DMC, and most preferably, ethylene glycol, propylene glycol, water or a solution containing a mixture thereof.

The current collector used in the electrode of the waste secondary battery according to the present disclosure may include at least one selected from the group consisting of aluminum (Al), copper (Cu), nickel (Ni), stainless steel and aluminum alloy, and may generally have a foil-like shape having a thickness of 5-50 μm. In addition, recently, various shapes of current collectors, such as a mesh-like current collector, may be used to improve mileage and output characteristics of electric vehicles, and there is no particular limitation in use of a current collector.

The cathode mixture used in the electrode of the waste secondary battery according to the present disclosure may include a lithium-containing composite transition metal oxide or transition metal cathode together with a conductive agent and binder. The cathode has a structure including a cathode active material formed on conductive aluminum foil, which may be foil functioning as a current collector. The cathode active material layer is one including a cathode active material mixed with a binder, wherein the binder functions to entangle the cathode active material particles for the purpose of shape retention, and the cathode active material may be bound with the aluminum foil by the binder.

According to the present disclosure, the cathode active material may be at least one selected from the group consisting of lithium (Li), nickel (Ni), cobalt (Co), manganese (Mn), aluminum (Al) and a mixture thereof. For example, the cathode active material may be lithium cobalt oxide (LiCoO₂), lithium nickel oxide (LiNiO₂), lithium nickel manganese cobalt (NCM), lithium iron phosphate (LFP), or the like, and oxide in which the central metal in the active material composition is doped with another transition metal, or an active material including a doped oxide surface-coated with a transition metal oxide, fluoride or lithium-containing oxide, but is not limited thereto.

The cathode active material is a key material determining battery capacity, and may be used in an amount of 70-100 wt %, specifically 75-98 wt %, based on the total weight (wt %) of the whole cathode mixture.

The conductive agent of the cathode mixture is used to impart conductivity to the electrode, and particular examples thereof may include: graphite, such as natural graphite or artificial graphite; carbonaceous materials, such as carbon black, acetylene black, Super-P, Super-C, carbon nanotubes, Ketjen black, channel black, furnace black, lamp black, thermal black or carbon fibers; or conductive polymers, such as polyphenylene derivatives. Such conductive agents may be used alone or in combination. The conductive agent may be used in an amount of 0.5˜20 wt % based on the total weight of the cathode mixture.

The binder of the cathode mixture is used to improve the attachment between the cathode active material and conductive agent particles and the adhesion of the cathode mixture with the current collector, and particular examples thereof may include polyvinylidene fluoride (PVDF), polyvinylidene fluoride-co-hexafluoropropylene (PVDF-co-HFP), polyacrylonitrile, carboxymethyl cellulose (CMC), polyvinyl alcohol, starch, hydroxypropyl cellulose, regenerated cellulose, polyvinyl pyrrolidone, polytetrafluoroethylene (PTFE), polyethylene, polypropylene, ethylene-propylene-diene rubber (EPDM), sulfonated EPDM, styrene-butadiene rubber (SBR), fluoro-rubber, or various copolymers thereof. Such binders may be used alone or in combination. The binder may be used in an amount of 0.5-20 wt % based on the total weight of the cathode mixture.

In another aspect of the present disclosure, there is provided an electrode material derived from waste secondary batteries or unused secondary batteries, obtained by the method according to the present disclosure.

In still another aspect of the present disclosure, there is provided a lithium-ion secondary battery including the electrode material derived from waste secondary batteries or unused secondary batteries, obtained by the method according to the present disclosure.

The lithium-ion secondary battery including an electrode material, recovered and recycled from discarded, faulty or unused secondary batteries (die cut electrode), may be used widely for electronics, such as electronic instruments, portable computers, cellular phones, or the like.

The current collector and the cathode or anode active material, recovered from discarded or unused secondary batteries according to the method of the present disclosure, are separated and recovered through a non-destructive process and is advantageous in that they show no significant difference from the existing materials before and after recycling. Therefore, the current collector and the cathode or anode active material are recovered in a form capable of being used directly with no additional process in manufacturing batteries, and thus can realize an effect of facilitating recycling.

Particularly, unlike conventional technologies, it can be confirmed through the following examples and test examples that aluminum, which is a commonly used cathode current collector, can be completely recovered in the form of foil rather than in a molten form.

Hereinafter, preferred examples of the present disclosure will be described so that the present disclosure may be understood with ease. However, it should be understood that such preferred examples are given by way of illustration only, and the scope of the present disclosure is not limited thereto. It is apparent to those skilled in the art that various changes and modifications may be made within the scope of the present disclosure.

### EXAMPLES

### Example 1-1. Recovery of Electrode Materials Under Vacuum Plasma Condition Using Aqueous Acetone Solution

\textcircled{1} Vacuum plasma is applied to the surface of a cathode separated from a secondary battery under the atmosphere of mixed gas of argon with oxygen at 200 W for 15 minutes.

\textcircled{2} The binder wrapping the NCM (Ni—Co—Mn) cathode active material, and the conductive agent are separated from the cathode active material by plasma, while the binder and the conductive agent are agglomerated.

\textcircled{3} The cathode (cathode active material, conductive agent, binder, aluminum current collector) surface treated with plasma is introduced to a container, the container is filled with acetone, and ultrasonic waves are applied thereto to separate the electrode materials (cathode active material, conductive agent, binder) quickly from the aluminum current collector.

\textcircled{4} The separated current collector is recovered after washing the surface impurities, and the slurry-like precipitate is recovered and dried.

\textcircled{5} The dried slurry is dipped in an aqueous solution containing acetone, heating is carried out to the boiling point of acetone or lower to separate the active material from the binder and the conductive agent.

\textcircled{6} The floating binder and the conductive agent are removed, and the precipitated active material is obtained and dried.

Further, if necessary, the obtained active material is heat treated at a temperature of 300-900° C. for 30 minutes to 3 hours.

### Example 1-2. Recovery of Electrode Materials Under Vacuum Plasma Condition Using Mixed Solution of Acetone with Ethylene Glycol

The same procedure as Example 1-1 was repeated, except that a mixed solution of acetone with ethylene glycol (EG) was used instead of the aqueous solution containing acetone in \textcircled{5} of Example 1-1, and that heating was carried out to a temperature close to the boiling point of acetone or to the boiling point of ethylene glycol or lower.

### Example 1-3. Recovery of Electrode Materials Under Vacuum Plasma Condition Using Mixed Solution of Acetone with Propylene Glycol

The same procedure as Example 1-1 was repeated, except that a mixed solution of acetone with propylene glycol (PG) was used instead of the aqueous solution containing acetone in \textcircled{5} of Example 1-1, and that heating was carried out to a temperature close to the boiling point of acetone or to the boiling point of propylene glycol or lower.

### Example 2. Recovery of Electrode Materials Under Atmospheric Pressure Plasma Condition

The same procedure as Example 1 was repeated, except that plasma was applied under the atmosphere of air or oxygen gas in \textcircled{1} of Example 1-1.

### TEST EXAMPLES

### Test Example 1. Analysis Before/after Plasma Treatment

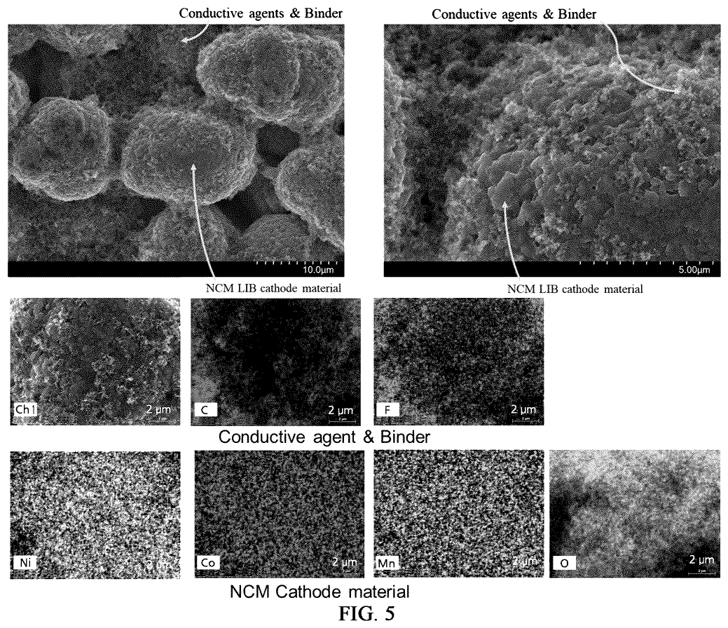

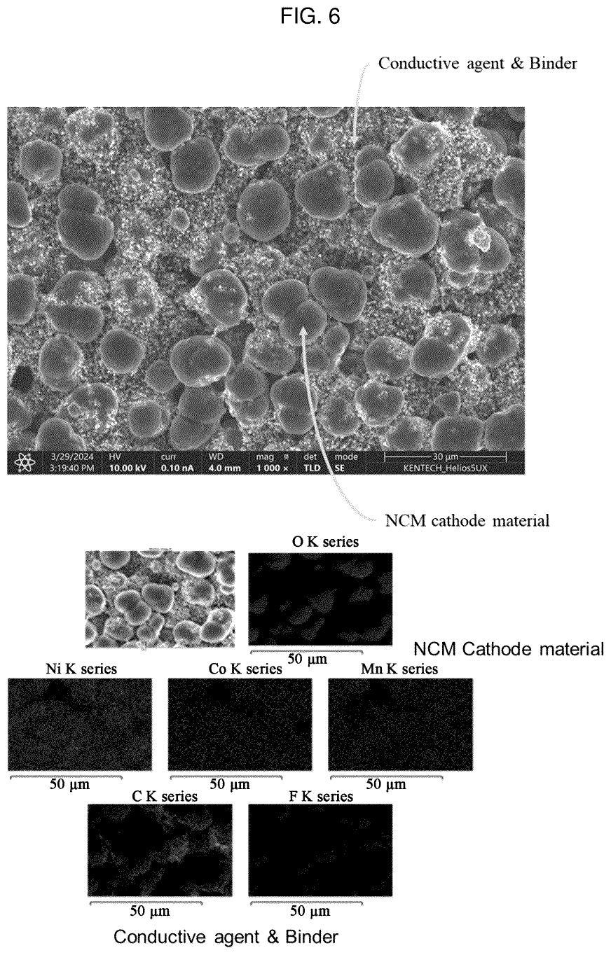

To check separation of the binder and the conductive agent from the cathode active material by the vacuum plasma process according to Example 1-1, scanning electron microscopy (SEM) and energy dispersive spectroscopy (EDS) were carried out before and after the plasma treatment. The results are shown in FIG. 5 and FIG. 6. FIG. 5 shows results before the plasma treatment, and FIG. 6 shows results after the plasma treatment.

Referring to FIG. 5, it can be seen from the cathode before the plasma treatment that the binder and the conductive agent well cover the circular NCM cathode active material uniformly.

Referring to FIG. 6, it can be seen from the cathode after the plasma treatment that the binder and the conductive agent that covered the cathode active material are separated.

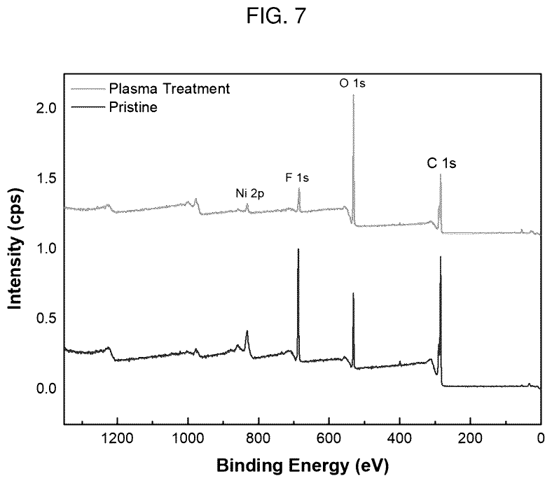

In addition, X-ray photoelectron spectroscopy (XPS), EDS and Raman analysis were further carried out. The results are shown in FIG. 7 to FIG. 9.

Referring to FIG. 7, when comparing XPS peaks before the plasma treatment with those after the plasma treatment, it can be seen that F and C peaks are reduced after the plasma treatment, which suggests that the binder on the electrode surface is separated from the cathode active material.

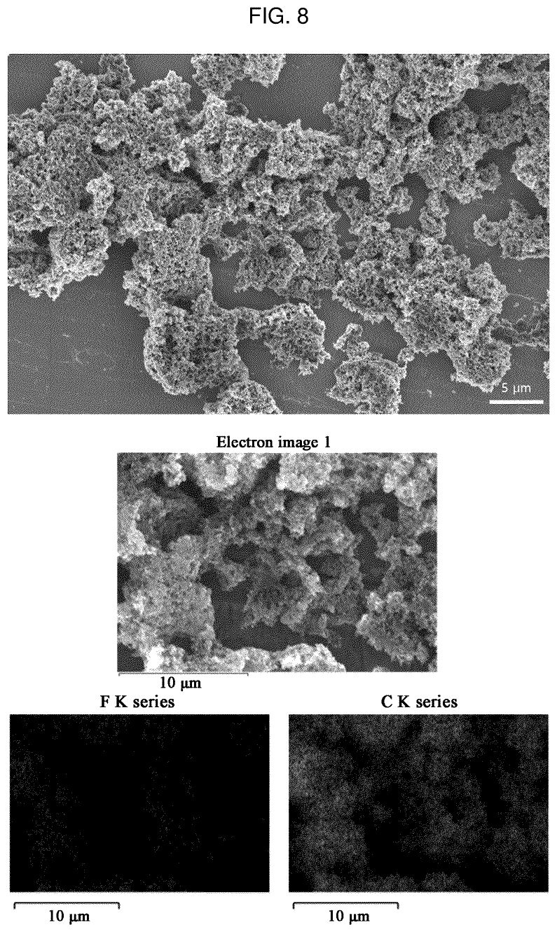

FIG. 8 shows an SEM image and EDS analysis result of the conductive agent and the binder remaining after being separated from a NCM cathode active material.

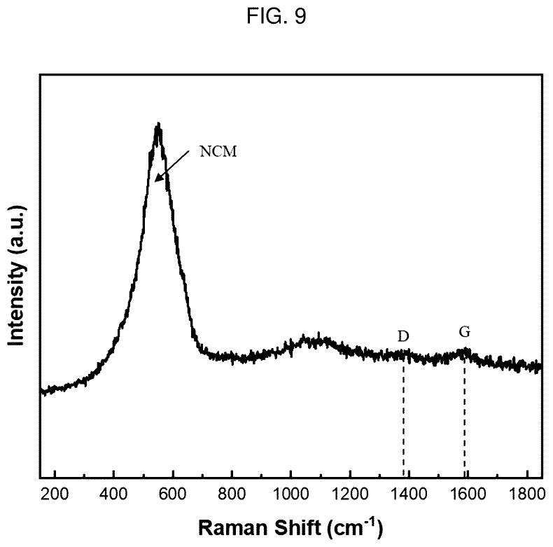

FIG. 9 is a graph illustrating results of Raman analysis of the separated NCM cathode active material, and it can be seen that any peaks of the conductive agent and the binder are not identified other than peaks of NCM.

Therefore, it can be seen from the above results of Test Example 1 that the cathode active material is separated from the conductive agent and the binder by the vacuum plasma process according to the present disclosure.

### Test Example 2. Analysis of Current Collector and Active Material Before/after Process

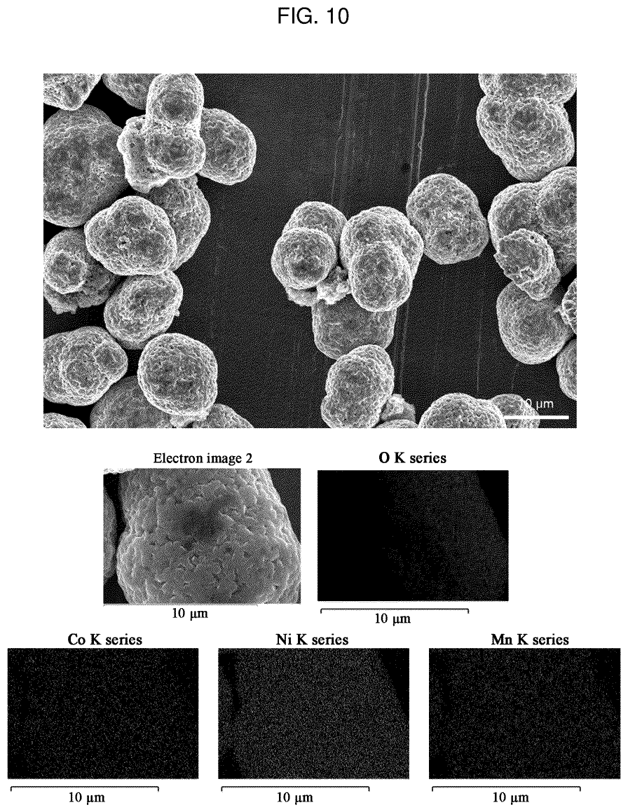

To determine that the active material and the current collector recovered according to Example 1-1 shows no difference in ingredients and states before/after the process, SEM, EDS, X-ray diffractometry (XRD), X-ray photoelectron spectroscopy (XPS), atomic force microscopy (AFM) and I-V curve analysis were carried out. The results are shown in FIG. 10 to FIG. 17.

FIG. 10 shows results of SEM and EDS analysis of the cathode active material recovered according to the present disclosure, and it can be seen that all impurities, including the conductive agent and the binder, are removed after completing the process, and the NCM cathode active material is recovered as it is with no change in shape or chemical structure.

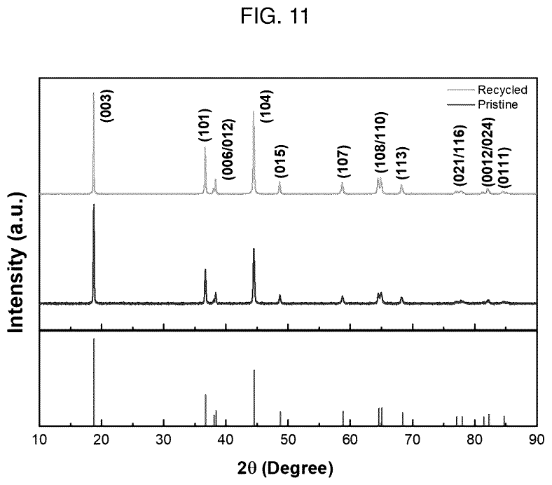

FIG. 11 is a graph illustrating results of X-ray diffractometry (XRD) analysis of the cathode active material recovered according to the present disclosure, and it can be seen that the cathode active material undergoes no deformation before and after the process since there is no change in peaks before and after the process.

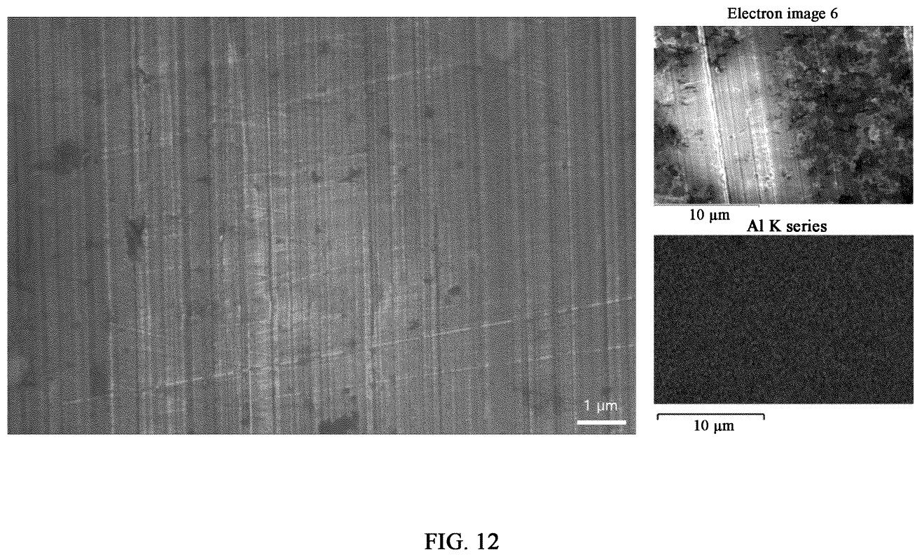

FIG. 12 shows results of SEM and EDS analysis of the aluminum current collector recovered according to the present disclosure, and it can be seen that the current collector recovered by the process show no damage on the surface and the recovered current collector includes Al elements.

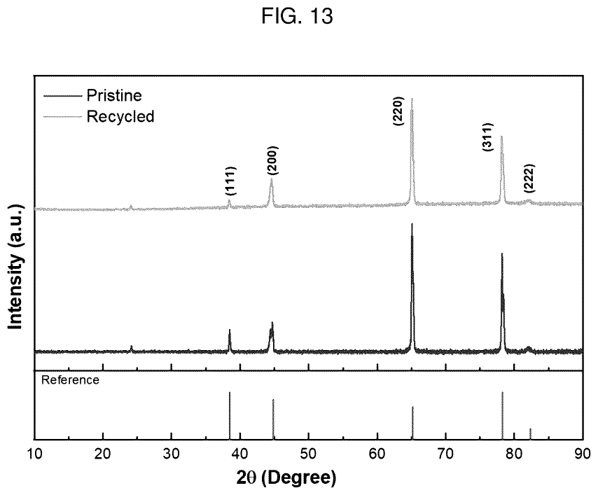

FIG. 13 is a graph illustrating results of XRD analysis of the aluminum current collector according to the present disclosure, and it can be seen that the current collector undergoes no deformation before and after the process since there is no change in peaks before and after the process.

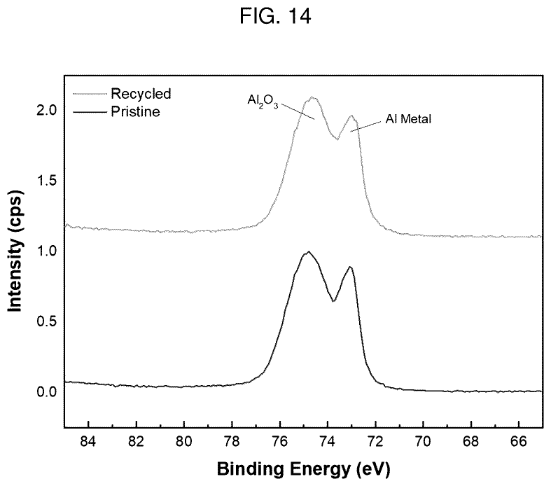

FIG. 14 is a graph illustrating results of XPS analysis of the aluminum current collector according to the present disclosure, and it can be seen that the current collector undergoes no deformation before and after the process since there is no change in peaks before and after the process.

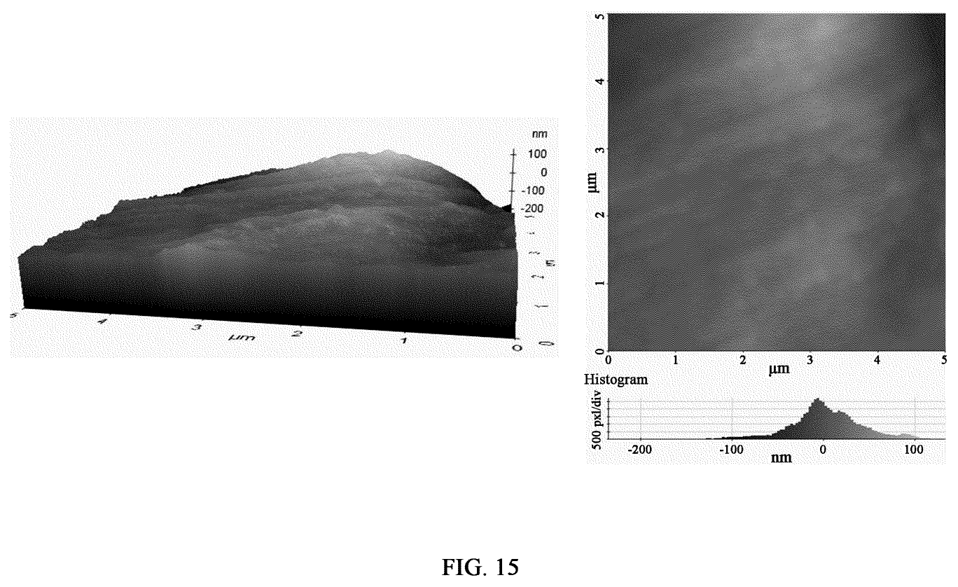

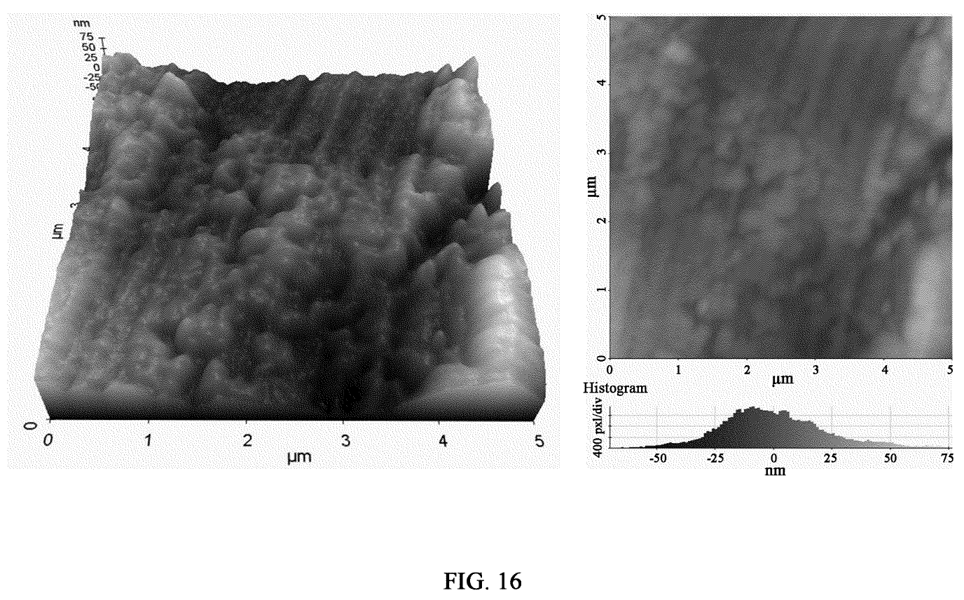

FIG. 15 and FIG. 16 show results of atomic force microscopy (AFM) analysis of the current collector and illustrate the current collector before and after the process, respectively. Referring to FIG. 15 and FIG. 16, there is little change before and after the process, and thus it can be seen that the aluminum current collector recovered through the process according to the present disclosure shows no damage on the surface.

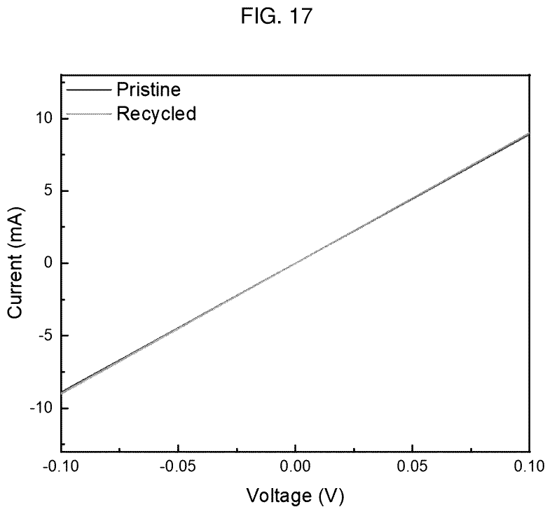

FIG. 17 is a graph illustrating an I-V curve of the current collector recovered according to the present disclosure, and it can be seen that the graphs before and after the process substantially coincide, and thus the aluminum current collector recovered through the process according to the present disclosure undergoes no deformation.

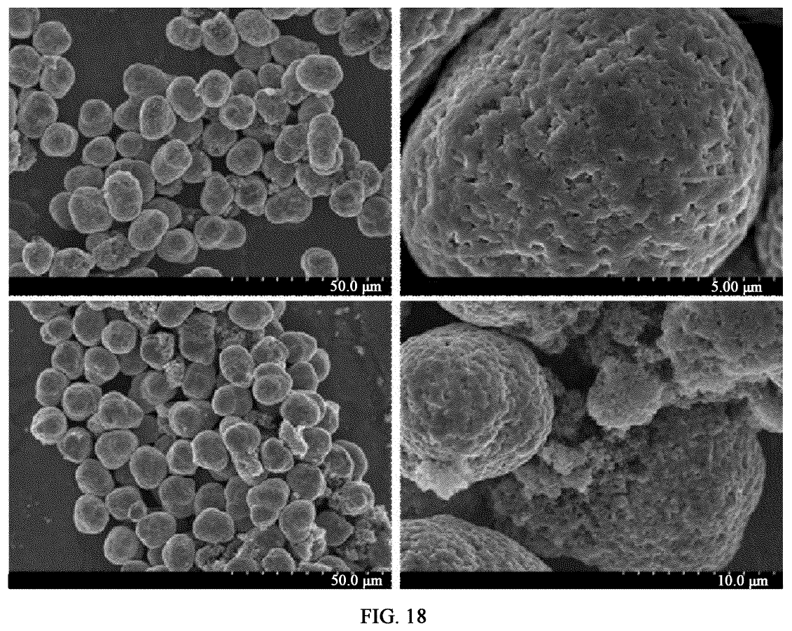

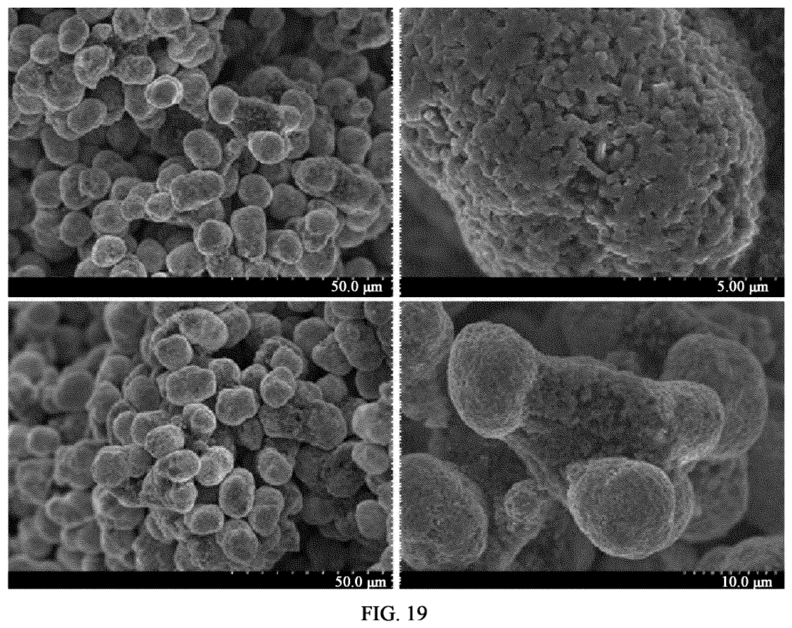

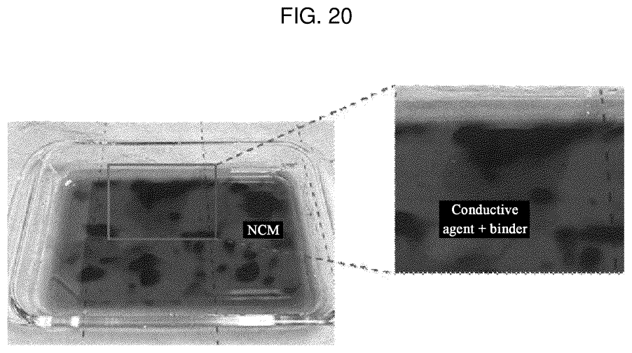

In addition, FIG. 20 illustrates a process of separating and recovering a cathode active material according to Example 1-2 in which a mixture of organic solvents is used instead of an aqueous solution containing an organic solvent. To check that the active materials and current collectors recovered according to Examples 1-2 and 1-3 show no difference in ingredients and states before/after the process, SEM analysis is carried out and the results are shown in FIG. 18 and FIG. 19, respectively.

FIG. 18 shows results of SEM analysis of the cathode active material recovered according to Example 1-2, and it can be seen that the cathode active material recovered after completing the process shows a clear surface, which suggests that the cathode active material is recovered as it is with no change in shape or chemical structure.

FIG. 19 shows results of SEM analysis of the cathode active material recovered according to Example 1-3, and it can be seen that the cathode active material recovered after completing the process shows a clear surface, which suggests that the cathode active material is recovered as it is with no change in shape or chemical structure.

Therefore, it can be seen from the results of Test example 2 that a cathode active material and a current collector can be recovered as they are with no deformation and damage from unused lithium secondary batteries through the process according to the present disclosure.

What is claimed is:

1. A method for recycling a secondary battery electrode material, comprising the steps of:
(A) applying vacuum plasma or atmospheric pressure plasma to the surface of a secondary battery electrode to perform plasma treatment;
(B) dipping the plasma-treated electrode in a first organic solvent or in water or mixture of water/organic solvent and carrying out ultrasonication; and
(C) dipping the ultrasonicated electrode in a solution containing the first organic solvent and carrying out heating to the boiling point of the first organic solvent or lower,
wherein the solution of step (C) is a solution containing a mixture of the first organic solvent with water or a second organic solvent.

2. The method for recycling a secondary battery electrode material according to claim 1, wherein the electrode is a cathode comprising a cathode active material, a cathode current collector, a conductive agent and a binder, or an anode comprising an anode active material, an anode current collector, a conductive agent and a binder.

3. The method for recycling a secondary battery electrode material according to claim 1, which further comprises step (D) of heat treating the cathode active material or anode active material obtained through step (C).

4. The method for recycling a secondary battery electrode material according to claim 3, wherein the heat treating is carried out at 300-900° C. for 30 minutes to 3 hours.

5. The method for recycling a secondary battery electrode material according to claim 1, which further comprises (a-1) a pretreatment step of separating a cathode, an anode and a separator from a secondary battery discarded after use, before step (A).

6. The method for recycling a secondary battery electrode material according to claim 1, wherein the vacuum plasma in step (A) is applied for 5 minutes to 1 hour through plasma discharge under the atmosphere of a mixed gas containing argon (Ar) at 10-1000 W, and
the mixed gas is a gas containing argon (Ar) mixed with at least one selected from the group consisting of oxygen (O₂), hydrogen (H₂) and nitrogen (N₂).

7. The method for recycling a secondary battery electrode material according to claim 1, wherein the atmospheric pressure plasma in step (A) is applied for 5 minutes to 1 hour through plasma discharge under the atmosphere of oxygen (O₂) or nitrogen (N₂) alone, or a mixed gas containing argon (Ar) at 10-1000 W, and
the mixed gas is a gas containing argon (Ar) mixed with at least one selected from the group consisting of oxygen (O₂), hydrogen (H₂), nitrogen (N₂) and helium (He).

8. The method for recycling a secondary battery electrode material according to claim 1, wherein the first organic solvent is at least one selected from the group consisting of acetone, ethanol, methanol, benzene, chloroform, ethylene dichloride, ethyl acetate, acetonitrile, n-hexane, cyclohexane, tetrahydrofuran (THF), N-methyl pyrrolidone (NMP), dimethyl carbonate (DMC), ethyl carbonate (EC) and a mixture thereof.

9. The method for recycling a secondary battery electrode material according to claim 1, wherein the second solvent is at least one selected from the group consisting of ethylene glycol (EG), propylene glycol (PG), triethylene glycol (TEG), polyethylene glycol (PEG), NMP, DMC, EC and a mixture thereof.

10. The method for recycling a secondary battery electrode material according to claim 1, wherein the current collector is at least one selected from the group consisting of aluminum (Al), copper (Cu), nickel (Ni), stainless steel and aluminum alloy.

11. The method for recycling a secondary battery electrode material according to claim 1, wherein the cathode active material is at least one selected from the group consisting of lithium (Li), nickel (Ni), cobalt (Co), manganese (Mn), aluminum (Al), iron (Fe), titanium (Ti) and a mixture thereof.

12. An electrode material derived from waste secondary batteries or unused secondary batteries, obtained by the method as defined in claim 1.

13. A lithium-ion secondary battery comprising the electrode material derived from waste secondary batteries or unused secondary batteries as defined in claim 12.
